(19) United States
(12) Patent Application Publication
(10) Pub. No.: US 2015/0183189 A1
(43) Pub. Date: Jul. 2, 2015

(54) Graphene Hydrogel, Graphene Hydrogel Nanocomposite Materials, and Preparation Method Thereof

(71) Applicants: Institute for Basic Science, Daejeon (KR); Korea Advanced Institute of Science and Technology, Daejeon (KR)

(72) Inventors: Sang Ouk Kim, Daejeon (KR); Uday Narayan Maiti, Daejeon (KR); Joon Won Lim, Daejeon (KR)

(21) Appl. No.: 14/452,995

(22) Filed: Aug. 6, 2014

(30) Foreign Application Priority Data
Dec. 26, 2013 (KR) 10-2013-0163708

(51) Int. Cl. B32B 18/00; B32B 37/24; B32B 37/00; B32B 7/04; B32B 7/00

(52) U.S. Cl. CPC B32B 18/00; B32B 7/045; B32B 7/005; B32B 37/0038; B32B 37/24; C04B 2237/363; C04B 2237/62

(57) ABSTRACT

Provided are a graphene hydrogel, graphene hydrogel nanocomposite materials, and a preparation method thereof, wherein the graphene hydrogel includes pores between laminated graphene sheets, and the pores contain moisture. In addition, the graphene hydrogel nanocomposite materials include nanoparticles and porous pores between laminated graphene sheets, and the pores contain water.

### CROSS-REFERENCE TO RELATED APPLICATION

This application claims priority to Korean Patent Application No. 10-2013-0163708 filed Dec. 26, 2013, the disclosure of which is hereby incorporated in its entirety by reference.

### TECHNICAL FIELD

The present invention relates to a three-dimensional laminated structure of a thin film graphene hydrogel, and more particularly, to a graphene hydrogel having large area prepared by a simplified process, graphene hydrogel nanocomposite materials containing the graphene hydrogel and nanoparticles, and a preparation method thereof.

### BACKGROUND

Generally, graphite has a laminated structure of graphene which is a two-dimensional planar sheet formed of hexagonally arranged carbon atoms. Such graphite may be exfoliated into a nanometer-thick graphene sheet of single or several layers, wherein the exfoliated graphene sheet has various advantages compared with the existing graphite.

Specifically, a graphene sheet has many advantages such as significantly excellent electrical and thermal conductivities, high mechanical strength and elasticity, high transparency, and the like. Therefore, graphene sheet may be used in various purposes such as energy storage materials such as a secondary battery, a fuel cell and a super capacitor, a filtration membrane, a chemical detector, a transparent electrode, and the like.

As an application of such graphite, a nanographite structure is being widely studied, and among those studies, a study for utilization of nanometal-graphene composite is actively in progress.

Meanwhile, as a conventional technique for preparing a metal-graphene composite of nanostructure from graphite, a technique to produce metal nanoparticles after reducing graphite oxides or graphene oxides using a reducing agent, wherein the reducing agent is used together with graphite oxides or graphene oxides to produce reduced graphite oxide and graphene oxide, then produce metal nanoparticles, and an organic ligand is used to connect metal nanoparticles and reduced graphene oxide.

Such known preparation method is advantageous in uniformity of dispersion and size of nanoparticles. However, the preparing process is complicated and it is problematic to maximize the catalytic activity of a nanocomposite due to the existence of remained organic materials and the use of a toxic reducing agent.

In addition, as the art related to a nanometal-graphene nanocomposite, Korean Patent No. 905526 suggests a technique related to protein wherein nanographite structure recognition peptide is fused in or chemically bonded to the surface of cage protein such as ferritin, and a nanographite structure-metal nanoparticle composite wherein plural nanoparticles of inorganic metal atom or inorganic metal compound are supported on a nanographite structure prepared using the protein; and Korean Patent Laid-Open Publication No. 2011-0073222 suggests a preparation method of graphene dispersion including dispersing graphite in ionic liquid to prepare graphene dispersion, and if ionic liquid in the preparation of graphene dispersion is a monomer, polymerizing it, or using polymer ionic liquid to prepare graphene-ionic liquid polymer composite, and graphene-ionic liquid polymer composite prepared from the dispersion and a preparation method thereof. However, such techniques aim to impart a characteristic to a composite, rather than improve a preparation process.

In addition, Korean Patent Laid-Open Publication No. 2011-0073296 suggests a technique to form a metal-carbon hybrid-type nanocomposite film by adsorbing metal nanoparticles on a carbon nanostructure; mixing the carbon nanostructure on which the metal nanoparticles are adsorbed with ionic compound liquid to obtain gel; mixing the gel with liquid including a polymer matrix, then adding conductive metal powder, and mixing it to obtain metal-carbon hybrid-type nanocomposite solution; applying the metal-carbon hybrid-type nanocomposite solution on a mold, then drying it to form a metal-carbon hybrid-type nanocomposite film; and Korean Patent Laid-Open Publication No. 2011-0038721 relates to a method capable of advantageously preparing graphene/SiC composite materials formed by laminating flat large-area graphene on a SiC single crystal mold, and suggests a technique to form a SiO₂ layer on Si surface by performing a removing treatment of an oxide coating formed by natural oxidation on the SiC single crystal mold to expose Si surface of a SiC single crystal mold, then heating the SiC single crystal mold having exposed Si surface under oxygen atmosphere.

However, these techniques are only focused on characterization or diversification of the properties of nanocomposite, and there is still demand for a method capable of simply preparing a graphene nanocomposite from graphite, and also producing a commercially available large-area graphene film, from graphite.

### RELATED ART DOCUMENT

### Patent Document

1. Korean Patent No. 10-0905526

2. Korean Patent Laid-Open Publication No. 2011-0073222

3. Korean Patent Laid-Open Publication No. 2011-0073296

4. Korean Patent Laid-Open Publication No. 2011-0038721

### SUMMARY

An embodiment of the present invention is directed to providing a micro-sized thin film graphene hydrogel having large area prepared by a simplified process, in preparation of a three-dimensional laminated structure of a thin film graphene hydrogel. At the same time, it is directed to providing a graphene hydrogel having improved electrical conductivity and ion transport ability by including pores.

Another embodiment of the present invention is directed to providing graphene hydrogel nanocomposite materials capable of guaranteeing significantly excellent electrical conductivity by improving dispersion of nanoparticles in a graphene sheet, in preparation of graphene-nanocomposite.

Another embodiment of the present invention is directed to providing a preparation method of a graphene hydrogel capable of preparing a large-area graphene hydrogel having improved electrical conductivity and ion transport ability without limitation of size and shape by a simplified process.

Another embodiment of the present invention is directed to providing a preparation method of graphene hydrogel nanocomposite materials having excellent quality by uniformly dispersing nanoparticles in a graphene sheet by a simplified process.

In one general aspect, a graphene hydrogel includes pores between laminated graphene sheets.

The graphene sheets may be laminated in a quasi-aligned manner.

The pores may contain moisture.

In another general aspect, graphene hydrogel nanocomposite materials include nanoparticles within pores between laminated graphene sheets.

The graphene sheets are laminated in a quasi-aligned manner.

The pores contain water.

The nanoparticles may be contained in the pores.

The nanoparticles may be one kind of nanoparticles, or two or more kinds of mixed nanoparticles selected from metal nanoparticles, precious metal nanoparticles, carbon nanoparticles, polymer nanoparticles, organic/inorganic hybrid nanoparticles, and oxides thereof.

In another general aspect, a preparation method of a graphene hydrogel includes preparing a graphene oxide solution; and immersing a metal mold in the graphene oxide solution to laminate graphene sheets on the surface of the metal mold, thereby forming a graphene gel, wherein pores are contained between the laminated graphene sheets.

In the forming of a graphene gel on the surface of the metal mold, as the graphene oxides are spontaneously reduced on the surface of the metal mold, the graphene sheets are deposited on the surface of the metal mold in a laminated form.

In another general aspect, a preparation method of graphene hydrogel nanocomposite materials includes preparing a mixed solution of graphene oxides and nanoparticles, and immersing a metal mold in the mixed solution to laminate graphene sheets on the surface of the metal mold, thereby forming a graphene gel containing nanoparticles, wherein the nanoparticles are contained within pores between the laminated graphene sheets.

In the forming of the graphene gel containing the nanoparticles, as the graphene oxides are reduced on the surface of the metal mold, the graphene sheets get deposited on the surface of the metal mold in a laminated form, and the nanoparticles are contained in the pores formed by lamination of the graphene sheets.

In the preparation method of graphene hydrogel nanocomposite materials, thin film fabric may be adhered to the surface of the metal mold.

In another general aspect, an article is manufactured using the graphene hydrogel or the graphene hydrogel nanocomposite materials as described above, and the article may be one of an energy storage device, an electromagnetic wave shielding material, a wastewater treatment reagent, an electrocatalyst material, a cell growth plate, and a graft material.

Other features and aspects will be apparent from the following detailed description, the drawings, and the claims.

### BRIEF DESCRIPTION OF THE DRAWINGS

FIG. 1 is a work process flow chart illustrating a preparation method of the graphene hydrogel according to an exemplary embodiment of the present invention;

FIG. 2 is a photograph of each process step showing the actual processing state of FIG. 1;

FIGS. 3-a to 3-c are conceptual diagrams showing the states of forming a graphene gel on the surface of the metal mold according to an exemplary embodiment of the present invention;

FIG. 4 is a photograph showing the graphene hydrogel prepared according to a preparation method of a graphene gel according to an exemplary embodiment of the present invention;

FIG. 5 is a cross-sectional SEM photograph of a graphene aerogel prepared by rapid cool drying the graphene hydrogel prepared according to an exemplary embodiment of the present invention;

FIG. 6 is a XPS spectra graph for C1s of the graphene aerogel of FIG. 5;

FIG. 7 is a graph comparing Raman spectrum of the graphene aerogel of FIG. 5 and graphene oxide of the present invention;

FIG. 8-a is photograph showing the appearance of the graphene hydrogel in three-dimensional form prepared according to another exemplary embodiment of the present invention, and FIG. 8-b is photograph showing a metal material in three-dimensional form used for preparing the graphene hydrogel, respectively;

FIG. 9 is a work process flow chart illustrating a preparation method of a graphene hydrogel nanocomposite materials according to another exemplary embodiment of the present invention;

FIGS. 10-a to 10-c are cross-sectional SEM photographs of the graphene hydrogel nanocomposite materials prepared according to another exemplary embodiment of the present invention, respectively; and

FIG. 11 is a schematic diagram explaining a preparation method of the graphene hydrogel nanocomposite materials according to another exemplary embodiment of the present invention.

### DETAILED DESCRIPTION OF EMBODIMENTS

Hereinafter, the graphene hydrogel, the graphene hydrogel nanocomposite materials, and the preparation method thereof according to the present invention will be described in detail with reference to the accompanying drawings. The drawings to be provided below are provided by way of example so that the idea according to the present invention can be sufficiently transferred to those skilled in the art to which the present invention pertains. Therefore, the present invention is not limited to the presented drawings below, and may be embodied in other forms. Also, the drawings presented below may be shown exaggerated in order to clarify the idea according to the present invention. Technical terms and scientific terms used in the present specification have the general meaning understood by those skilled in the art to which the present invention pertains unless otherwise defined, and a description for the known function and configuration obscuring the present invention will be omitted in the following description and the accompanying drawings.

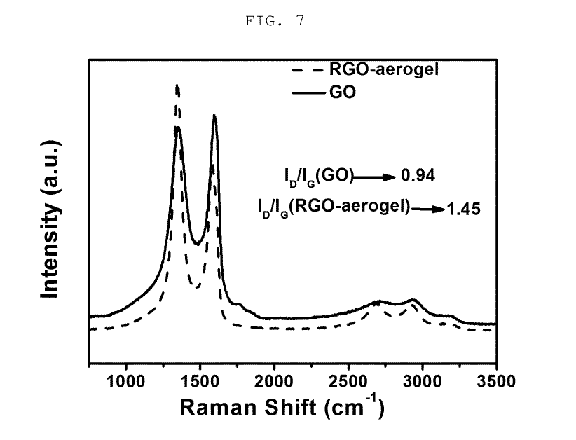

In the three-dimensional laminated structure of a thin film graphene hydrogel, the graphene hydrogel according to the present invention includes pores between laminated graphene sheets. In this case, the graphene sheets may be laminated in a quasi-aligned manner. In addition, the pores may be characterized by containing water (FIG. 5).

In this case, the graphene hydrogel according to the present invention may have improved electrical conductivity and ion transport ability, by including pores containing water.

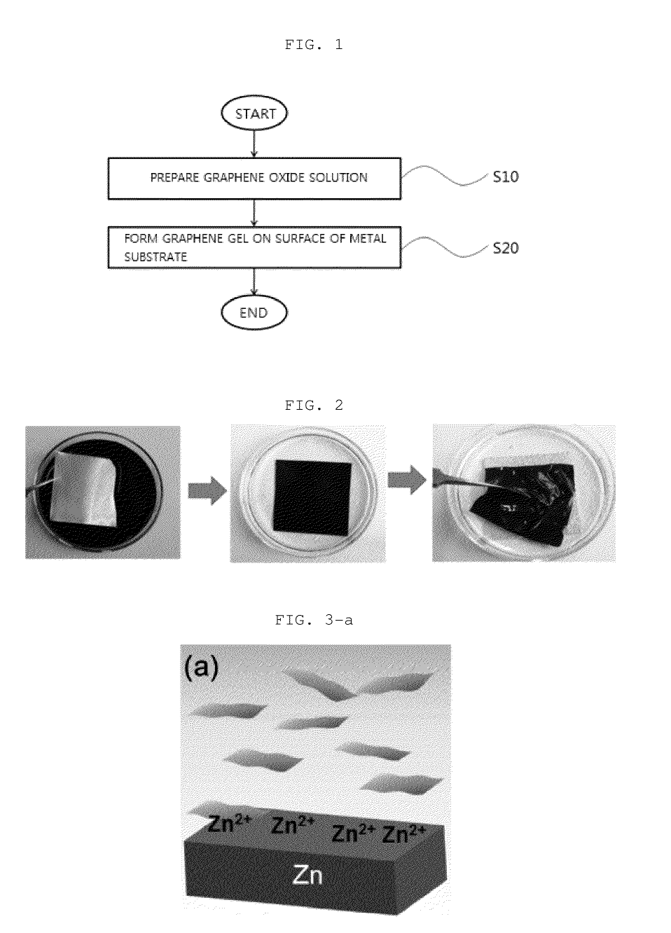

FIG. 1 is a work process flow chart illustrating the preparation method of the graphene hydrogel according to an exemplary embodiment of the present invention. Referring to FIG. 1, the preparation method of the graphene hydrogel according to the present invention includes preparing a graphene oxide solution, and immersing a metal mold in the graphene oxide solution, to laminate graphene sheets on a surface of the metal mold, thereby forming a graphene gel. In addition, thus prepared graphene gel may be formed in the form of hydrogel containing water in the pore formed as graphene sheets are laminated in a quasi-aligned manner. Specifically, the water content may be, in a non-limiting example, 90 wt % of the entire graphene gel. More preferably, 80 wt % of moisture is contained. Herein, the moisture naturally includes water, more specifically includes water molecule.

More specifically referring to the preparation method of a graphene hydrogel in FIG. 1, first, a graphene oxide solution is prepared (S10).

The graphene oxide solution may contain an acid solvent and graphene oxides.

In this case, the acid solvent may be any solvent having pH range of 1-4, and specific examples thereof include hydrochloric acid, nitric acid, sulfuric acid, and the like. However, hydrochloric acid is preferred to be used since its preparation and use is easy, and it prevents the occurrence of a rapid reaction due to an excessive reaction rate with a metal, and more specifically hydrochloric acid of pH 3 (0.001M HCl) is more preferred.

In addition, the preparation of graphene oxides may be non-restrictively carried out, but a typical method called Hummers method is mainly used. According to Hummers method, commercial graphite is impregnated in H₂SO₄ solution having high concentration at room temperature and sufficiently stirred, and then KMnO₄ is put into the solution in which graphite is impregnated. Subsequently, H₂O₂ is added in a predetermined amount to the mixed solution containing KMnO₄, then oxidation reaction of graphite occurs and graphite oxides are formed. Subsequently, powder obtained using a centrifuge after washing with distilled water and ethanol several times is sufficiently dried in an oven, thereby completing synthesis procedure of graphite oxides. Then, the graphite oxides are dispersed in water, and subjected to sonification, thereby exfoliating it into sheets of graphite oxides.

Thus prepared graphene oxides are mixed with previously prepared acid solvent to prepare graphene oxide solution. In this case, the graphene oxides in graphene oxide solution may be contained in the concentration of 0.1 to 5 mg/mL. Specifically, if the graphene oxides in graphene oxide solution is contained less than 0.1 mg/mL, the amount of contained graphene oxides is insignificant. Thus, the disadvantage of not forming a graphene hydrogel in a follow-up process, or taking too much time to form a graphene hydrogel may arise. Moreover, if the graphene oxides in graphene oxide solution is contained more than 5 mg/mL, the amount of contained graphene oxides is excessive, so that a graphene hydrogel is formed at a rapid rate in a follow-up process. Thus, the attractiveness of the surface may not be guaranteed.

Thereafter, a metal mold is immersed in the prepared graphene oxide solution, and graphene sheets are laminated on the surface of the metal mold, thereby forming a graphene gel (S20).

Specifically, if a metal mold in any shape is immersed in the graphene oxide solution as shown in the left of FIG. 2, after a certain time, graphene sheets are laminated on the surface of the metal mold to form a graphene gel, as shown in the middle of FIG. 2. Herein, immersion time is not specifically limited, but it may be preferred to form a graphene gel by immersion for 1 to 5 hours in view of smooth processing time. However, it may be advantageous to maintain immersion time for at least 1 hour for guaranteeing the thickness and quality of the prepared graphene gel.

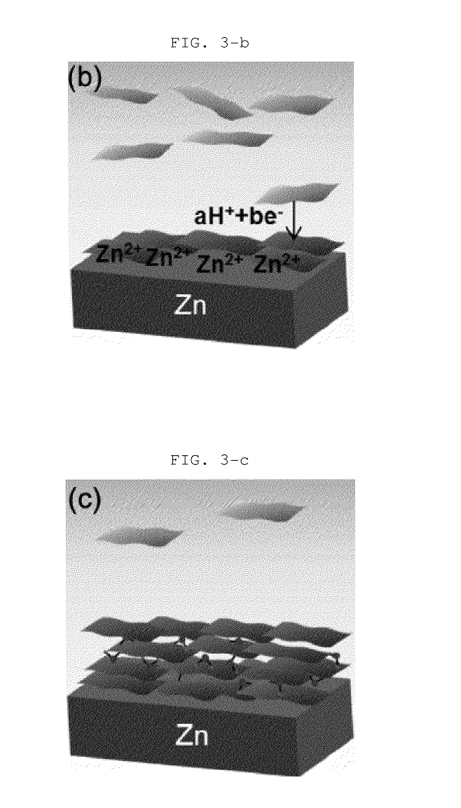

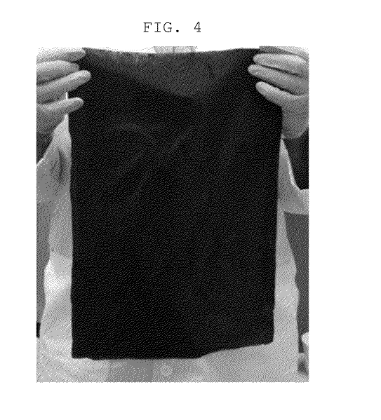

In detail, when a metal mold is immersed in a graphene oxide solution, as shown in the conceptual diagrams of FIGS. 3-a to 3-c, graphene oxides (red) are reduced to graphene sheets (violet) on the surface of the metal mold, thereby being laminated on the surface of the metal mold. Thus, it is deposited on the surface of the metal mold in the form of a graphene gel containing laminated graphene sheets. As such, the formation of the graphene gel according to the present invention is characterized by not requiring a separate reducing agent for preparing a graphene gel from graphene oxides, and since the graphene gel is deposited on the surface of the metal without limitation of the size and shape of the metal mold, the preparation process has an advantage of being very simple.

In this case, the metal mold may be selected from transition metal elements or post-transition metal elements for direct oxidation-reduction reaction with graphene oxides, and preferably, selected from copper, aluminum, nickel, iron, cobalt or zinc.

As described above, when the formation of a graphene gel on the surface of a metal mold is completed, it may be preferred to carry out washing process at least once before performing a follow-up process. In this case, washing is preferably carried out using water, specifically pure water or ultrapure water, more specifically water including distilled water, purified water, deionized water, and the like.

Such washing process is carried out in order to remove graphene oxide particles around the metal mold on which a graphene gel is formed, since in the state wherein a graphene oxide solution (in particular, graphene oxides in the graphene oxide solution) is remained around the metal mold on which a graphene gel is formed, as a follow-up process progresses, the reduction and the electroless deposition of graphene oxides may be partly and non-uniformly generated. The washing is done to remove unreduced graphene oxide sheets adsorbed over the formed gel over metal mold.

Meanwhile, thus formed graphene gel may be used by commercializing it as an article in the state attached to the metal mold according to its use, or commercializing it after removing the metal mold on which the graphene gel is formed.

In this case, the removal of the metal mold may be carried out by chemical etching by a strong acid. Specifically, as shown in the right of FIG. 2, the metal mold on the surface of which the graphene gel is formed, is immersed in a strong acid solution, thereby releasing the graphene gel from the metal mold. The strong acid solution in this case only acts on the release of the graphene gel from the metal mold by acid etching of zinc, and does not have a chemical effect on the graphene gel.

Such strong acid solution used in removal of the metal mold is non-restrictive, but preferably diluted to be used, in view of efficiently practicing the removal of the metal mold without generating an unwanted side reaction by the strong acid, and it is preferred to use at least 10-fold, more preferably at least 20-fold diluted solution.

At this time, when a graphene gel is released from the metal mold, it may be preferred to separately collect the released graphene gel, and additionally carry out a dialysis process. Herein, the dialysis process is carried out in order to remove acid impurities by the strong acid solution used at the time of removing the metal mold. Such dialysis process is carried out by conventional methods using at least one kind of water selected from pure water or ultrapure water, more particularly distilled water, purified water, deionized water, and the like.

In addition, as each process step according to the preparation method of the graphene gel according to the present invention progresses in the solution, the prepared graphene gel may be formed in the form of a hydrogel containing water in the pores. Specifically, the moisture (water) may be contained in 90 wt % of the entire graphene gel. More preferably, the moisture (water) may be contained in 80 wt %. Herein, the moisture naturally includes water, more specifically includes water molecule.

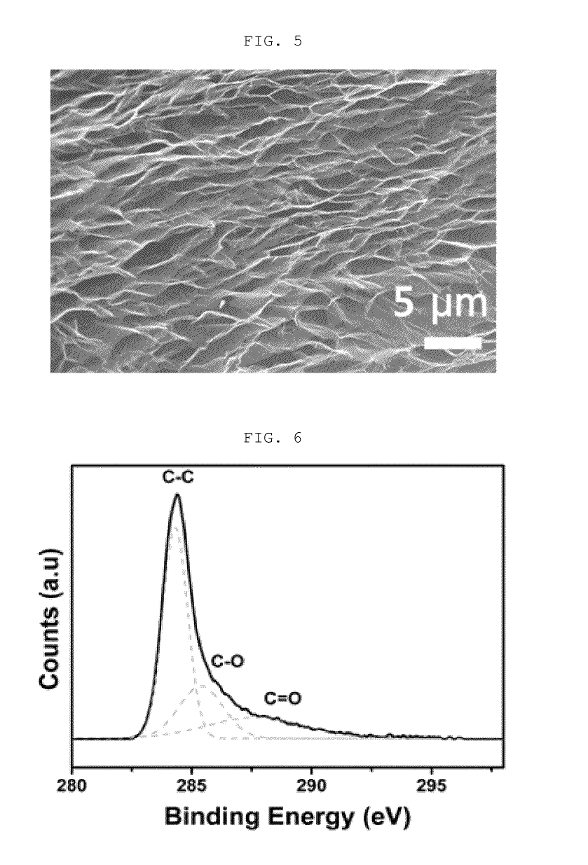

Looking into the graphene gel obtained by such method macroscopically, as shown in the photograph of FIG. 4, it may be in the form of flexible film. Herein, the graphene gel may be formed in variable shapes depending on the metal mold provided during the process, and especially the graphene gel having very large area may be non-restrictively formed depending on the size of the metal mold.

Meanwhile, looking into the graphene gel obtained by above described method microscopically, as shown in the conceptual diagrams of FIGS. 3-a to 3-c, plural graphene sheets are laminated in a quasi-aligned manner, and depending on the laminated state, pores having irregular shape may be formed between graphene sheets. A quasi-aligned manner means the case where plural graphene sheets are aligned in almost, but not completely parallel state, and as such, as graphene sheets are laminated in a quasi-aligned state, depending on the aligned state of the graphene sheets, porous pores may be formed between the graphene sheets. In addition, according to the characteristics of the present invention, the pore may contain moisture. Herein, the moisture naturally includes water, more specifically includes water molecule.

Subsequently, graphene hydrogel in the state of being attached to a metal mold, or obtained after completion of the removal of a metal mold may be subjected to drying process. Herein, the drying of the graphene hydrogel is carried out for the purpose of removing moisture contained in the porous pores of the graphene gel. In addition, the appearance of cross-section of the graphene gel from which moisture in the porous pores is removed through such drying may be seen in FIG. 5.

In this case, drying includes drying by critical point drying method, rapid cool drying, and the like, as described above, and rapid cool drying is preferred in view of reducing processing steps, and increasing efficiency. In addition, as the graphene hydrogel prepared through the above described process is turned into a graphene gel through such drying step, the graphene sheets wherein moisture is removed from the pores, but being aligned in a quasi-aligned manner, and thus formed pores are regarded as maintaining their appearance intact. It is considered that the more instant cooling is, that is, the faster cooling rate is, the more similar to each other the appearances of the graphene gel before and after cooling are.

However, if desired, the thickness of dried graphene hydrogel may be rather reduced compared with the thickness of the graphene hydrogel before being dried. Specifically, the degree of reduction is less than 30%, based on the thickness of graphene gel before being dried, and thus, the thickness of dried graphene gel may be in the level of 70% of its thickness before being dried.

Meanwhile, in order to check the single-layer of graphene hydrogel containing moisture, prepared graphene hydrogel may be dried using critical point drying method. Since the critical point drying method allows rapid and instant drying, compared with the rapid cool drying method as described above, the lamination form of initial graphene sheets of graphene hydrogel, or the thickness of porous pores, and the like may be changed to the minimum.

Meanwhile, FIG. 8-a shows the appearance of the graphene hydrogel pipe in three-dimensional form prepared according to another exemplary embodiment of the present invention, and FIG. 8-b is a photograph showing a metal material in three-dimensional form used for preparation thereof.

Referring to FIGS. 8-a and 8-b, a graphene gel pipe in three-dimensional stereoscopic form may be prepared by another exemplary embodiment of the present invention. Specifically, it is recognized that a metal material in three-dimensional stereoscopic form was provided instead of the metal mold to electroless deposit graphene gel on the surface of the three-dimensional metal material, and then the metal material was removed to form a graphene hydrogel pipe in three-dimensional form.

That is, it is recognized that the preparation of the graphene hydrogel according to the present invention has, hereby the advantage of freely forming graphene hydrogel, depending on the size or shape of metal mold or metal material provided without limitation of size or shape.

Hereinafter, the graphene hydrogel nanocomposite materials according to the present invention and the preparation method thereof will be described.

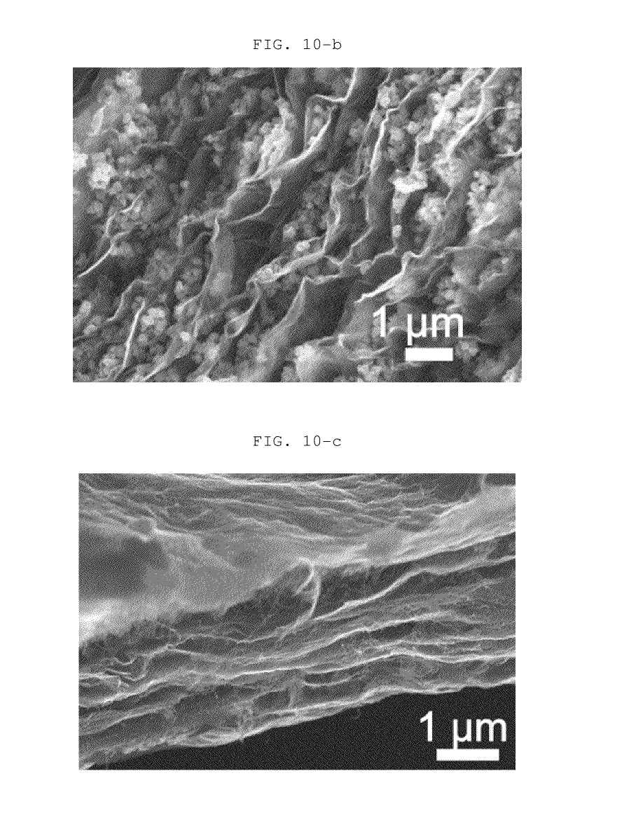

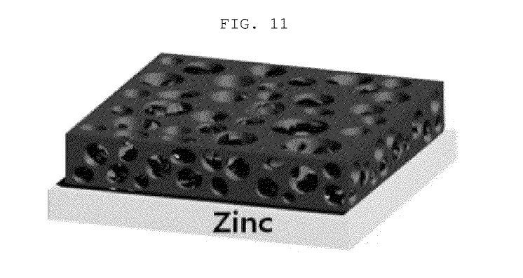

In the three-dimensional laminated structure of a thin film graphene hydrogel, graphene hydrogel nanocomposite materials is characterized by including nanoparticles within pores between laminated graphene sheets. In this case, the graphene sheets may be laminated in a quasi-aligned manner. In addition, the pores may contain moisture (FIGS. 10-a to 10-c).

In this case, the nanoparticles are characterized by being contained in the pores, wherein as the nanoparticles, metal nanoparticles, carbon nanoparticles, polymer nanoparticles, precious metal nanoparticles, and the like may be non-restrictively used depending on the use of the prepared graphene gel nanocomposite materials, and the characteristics of the prepared graphene gel nanocomposite materials depends on the physical properties of the used nanoparticles. Specifically, the nanoparticles may be used by selecting them from metal nanoparticles, precious metal nanoparticles, carbon nanoparticles, polymer nanoparticles, organic/inorganic hybrid nanoparticles, and oxides thereof, and at least two kinds of nanoparticles selected from the above nanoparticles may be simultaneously used to prepare graphene gel nanocomposite materials having improved various characteristics at the same time. More specifically, the nanoparticles may be used by selecting them from gold (Au), platinum (Pt), silver (Ag), titanium oxide (TiO₂), silicon (Si), carbon nanotube (CNT), carbon nanoparticles, and carbon nanocompound (eg., Fullerene, etc.).

As an example, silver (Ag) nanoparticles may be used for catalyst activation by the addition thereof, titanium oxide (TiO₂) nanoparticles may be used for photochemical catalyst activation by the addition thereof, carbon nanotube may be used for improving electrical conductivity by the addition thereof, and silicon (Si) nanoparticles may be used for the effects of deoxidation or reduction property by the addition thereof.

The content of nanoparticles in the nanoparticle dispersion in which the nanoparticles thus selected depending on its use are dispersed may be in the concentration of 1-5 mg/ml. Herein, if the content of nanoparticles in nanoparticle dispersion is less than 1 mg/ml, it is too insignificant to express the characteristics of the graphene gel to be desired depending on the physical properties of nanoparticles. In addition, if the content of nanoparticles in nanoparticle dispersion is more than 5 mg/ml, the content of nanoparticles in a mixed solution of graphene oxides and nanoparticles is excessive, so that the nanoparticles act as a factor to inhibit the reduction of graphene oxides and the electroless deposition of graphene sheet. Thus, the compact lamination of graphene sheets, or thereby tight formation of graphene network is failed, so that electrical characteristics may be deteriorated.

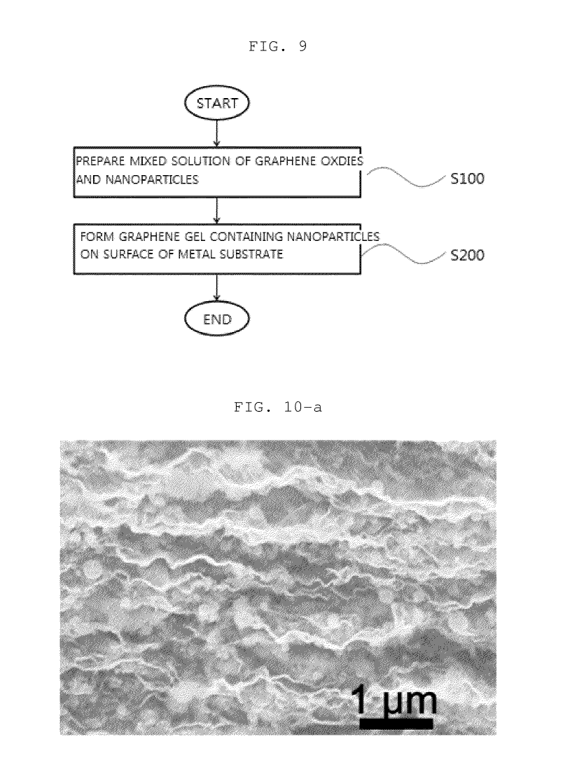

FIG. 9 is a work process flow chart illustrating a preparation method of the graphene hydrogel nanocomposite materials according to another exemplary embodiment of the present invention. Specifically, the preparation method of graphene hydrogel nanocomposite materials includes preparing a mixed solution of graphene oxides and nanoparticles, and immersing a metal mold in the mixed solution, to laminate graphene sheets on the surface of the metal mold, thereby forming a graphene gel containing nanoparticles. In addition, thus prepared graphene gel nanocomposite materials may be characterized by containing nanoparticles and moisture in porous pores formed by laminating reduced graphene sheets in a quasi-aligned manner. Specifically, the moisture (water) may be contained in 90 wt % in the entire graphene gel. More preferably, 80 wt % of moisture (water) may be contained. Herein, the moisture naturally includes water, more specifically includes water molecule.

Looking into the preparation method of a graphene hydrogel in FIG. 9 more specifically, first, a mixed solution of graphene oxides and nanoparticles is prepared (S100).

The mixed solution of graphene oxides and nanoparticles may be prepared by separately preparing graphene oxide solution and nanoparticle dispersion, then mixing them. Specifically, the mixed solution of graphene oxides and nanoparticles may be formed by preparing nanoparticle dispersion including distilled water and nanoparticles, preparing graphene oxide solution containing acid solution and graphene oxides, and mixing the nanoparticle dispersion and the graphene oxide solution.

Herein, as the nanoparticles, metal nanoparticles, carbon nanoparticles, polymer nanoparticles, precious metal nanoparticles, and the like may be non-restrictively used depending on the use of the graphene gel nanocomposite materials prepared as described above, and the characteristics of the prepared graphene gel nanocomposite materials may depend on the physical properties of the used nanoparticles.

The content of the nanoparticle in the nanoparticle dispersion may be 1-5 mg/ml. Herein, if the content of nanoparticles in nanoparticle dispersion is less than 1 mg/ml, it is too insignificant to express the characteristics of the graphene gel to be desired depending on the physical properties of nanoparticles. In addition, if the content of nanoparticles in nanoparticle dispersion is more than 5 mg/ml, the content of nanoparticles in a mixed solution of graphene oxides and nanoparticles is excessive, so that the nanoparticles act as a factor to inhibit the reduction of graphene oxides and the electroless deposition of graphene sheet. Thus, the compact lamination of graphene sheets, or thereby tight formation of graphene network is failed, so that electrical characteristics may be deteriorated.

In addition, the content of the graphene oxides in the graphene oxide solution may be 0.1-10 mg/ml. Herein, if the content of the graphene oxides in the graphene oxide solution is less than 0.1 mg/ml, the amount of the contained graphene oxides is insignificant, so that the compact lamination of graphene sheets may not be expected, and the phenomenon in which graphene hydrogel is not formed in the form of film in a follow-up process, may be generated. In addition, if the content of the graphene oxides in the graphene oxide solution is more than 10 mg/mL, the amount of the contained graphene oxides is excessive, so that the degree of dispersion of the graphene oxides is lowered, or graphene oxide residue is remained after washing. Thus, in the follow-up process of formation of graphene hydrogel, the aggregation of graphene sheets is generated, so that it may be difficult to guarantee the attractiveness of the surface of the prepared graphene gel.

In addition, in the preparation of a mixed solution of graphene oxide nanoparticles by mixing nanoparticle dispersion and the graphene oxide solution, the prepared nanoparticle dispersion is stirred, then the supernatant liquid may be separately collected, and mixed with graphene oxide solution. By the term supernatant liquid, if nanoparticle dispersion is stirred, and then stood for a certain period of time, it is separated into a depositing layer and a floating layer, and the supernatant liquid refers to the floating layer on top.

Meanwhile, the mixed solution of graphene oxides and nanoparticles may be prepared by the method of directly adding nanoparticles to the previously prepared graphene oxide solution and mixing them.

In addition, the acid solvent here may be any acid solution, and specific examples thereof include hydrochloric acid, nitric acid, sulfuric acid, and the like, but hydrochloric acid of pH 2-3 is preferred to be used for easy preparation and use, and for the generation of stabilized reaction with metal. Specifically, according to an exemplary embodiment of the present invention, acid solution of pH in the range of 1-4 may be used, and more specifically, 0.001 to 0.005M hydrochloric acid may be preferably used.

In addition, the preparation of graphene oxides may be carried out according to the preparation method of graphene hydrogel as described above.

Thereafter, a metal mold is immersed in the prepared graphene oxide solution, and a graphene gel containing nanoparticles is formed on the surface of the metal mold (S200). Herein, the procedures and the principle of graphene gel formation by immersion of the metal mold are as described in FIG. 2 and in FIGS. 3-a to 3-c above, and in the formation of such graphene gel, nanoparticles may be contained in the pores formed by the deposition of graphene gel by the alignment of graphene sheets.

In this case, the metal mold may be selected from transition metal elements or post-transition metal elements for direct oxidation-reduction reaction with graphene oxides, and preferably, selected from copper, aluminium, nickel, iron, cobalt or zinc.

According to the above description, when the formation of a graphene gel on the surface of a metal mold is completed, it may be preferred to carry out washing process at least once before performing a follow-up process. In this case, washing is preferably carried out using water, specifically pure water or ultrapure water, more specifically at least one kind of water selected from distilled water, purified water, deionized water, and the like.

Such washing process is carried out in order to remove graphene oxide particles around a metal mold on which a graphene gel is formed, since in the state wherein a graphene oxide solution (in particular, graphene oxides in the graphene oxide solution) is remained around the metal mold on which a graphene gel is formed, as a follow-up process progresses, the reduction and the electroless deposition of graphene oxides may be partly and non-uniformly generated during that time.

Meanwhile, thus formed graphene gel may be used in the attached state to the metal mold depending on its use, or used after removing the metal mold on which the graphene gel is formed.

In this case, the removal of the metal mold may be carried out by chemical etching by a strong acid. Specific etching method follows the above preparation method of graphene gel, and the acid solution in this case only acts on the release of graphene gel from the metal mold by acid etching the metal mold, and does not chemically act on nanoparticles or graphene gel.

Subsequently, when graphene gel containing nanoparticles is released from the metal mold, graphene gel containing the released nanoparticles is separately collected. In addition, as in the above preparation method of graphene gel, dialysis process for removing acid impurities may be additionally carried out.

The graphene gel nanocomposite materials obtained in this way may be macroscopically in the form of opaque flexible film, like the above graphene gel. Looking into it microscopically, as shown in FIGS. 10-a to 10-c, plural graphene sheets are laminated in a quasi-aligned manner, and as the graphene sheets are aligned, pores in irregular forms may be formed between the graphene sheets, depending on the state of lamination. In addition, as each process step according to the preparation method of the graphene gel nanocomposite materials according to the present invention progresses in the solution, the prepared graphene gel nanocomposite materials may be formed in the form of a hydrogel containing moisture in the pores. In addition, it may be in the form of containing nanoparticles added in the pores.

In addition, after the removal of the graphene hydrogel attached to the metal mold, or the metal mold is completed, the graphene hydrogel containing the obtained nanoparticles may be dried, and the specific drying process is identical to that of the graphene gel.

Meanwhile, according to another exemplary embodiment of the present invention, in the preparation method of the above described graphene gel nanocomposite materials, as a template for electroless deposition of the graphene gel containing nanoparticles, a metal mold to the surface of which a thin film porous substrate is adhered may be provided, as shown in FIG. 11.

Herein, the thin film substrate may be a cotton fabric, or a metal foam. More specifically, in order to increase affinity of the mixed solution of graphene oxides and nanoparticles to facilitate graphene gel formation, the thin film fabric may be prepared by wetting the fabric with a previously prepared graphene oxide solution Herein, the metal form may be made of nickel.

From the graphene gel nanocomposite materials prepared by the metal mold template to which such thin fabric is adhered, only the metal part of the template is removed by etching, thereby obtaining graphene gel nanocomposite materials in the mixed state of graphene gel containing nanoparticles and thin film fabric.

Meanwhile, if three-dimensional stereoscopic shape of the metal template is provided, as understood in the above preparation method of the graphene gel, it is natural to prepare the three-dimensional stereoscopic shape of graphene gel nanocomposite materials.

Furthermore, one of an energy storage device, an electromagnetic wave shielding material, a waste water treating reagent, an electrocatalyst material, a cell growth scaffold and a graft material may be manufactured using the graphene hydrogel or the graphene gel nanocomposite materials prepared according to the present invention.

Specifically, the energy storage device may include a secondary battery, a fuel cell, a super capacitor, and the like, and as it uses the graphene hydrogel or graphene gel nanocomposite materials according to the present invention, superior capacitance and electrical conductivity may be guaranteed.

In addition, depending on the physical properties of the graphene gel nanocomposite materials prepared according to the present invention, it may be applied to various fields such as a waste water treating agent or a filtration membrane, electrocatalyst materials or chemical detector, an electrowave shielding material or a transparent electrode, biomaterials such as a cell growth scaffold or a grafting material, and the like.

Hereinafter, Examples will be provided for a more specific understanding of the present invention. However, the present invention is not limited to the Examples.

### Preparation of Graphene Gel

### Example 1

Using graphene oxides prepared according to Hummers method (Bay Carbon Inc.), 6 mg/mL of a graphene oxide aqueous solution was prepared. The graphene oxide solution is diluted with pure water to 3 mg/ml and hydrochloric acid is added to the solution to make final PH of the solution 3, i.e., final concentration of acid in the graphene oxide solution is 0.001M. To the prepared graphene oxide aqueous solution, hydrochloric acid of pH 3 (=0.001M) was added, thereby diluting it to 3 mg/mL of graphene oxide solution.

After that, a zinc metal mold (Zn foil) was immersed in the prepared graphene oxide solution for 3 hours, and when a graphene gel was formed on the surface of the zinc metal mold, the mold was immersed in deionized water (D.I. water) for 20 minutes to remove graphene oxides residue.

The zinc metal mold on which a graphene gel was formed was immersed in 20 times diluted hydrochloric acid (HCl) for 4 hours, to release a graphene gel from the zinc metal mold, and obtain only a graphene gel. Subsequently, the obtained graphene gel was subjected to dialysis process with D.I. water to remove acid impurities.

The graphene hydrogel prepared according to the above process was subjected to rapid freeze-drying at −40° C. for 2 days, thereby obtaining a graphene aerogel. The SEM photograph of the resulting graphene aerogel is as shown in FIG. 5.

Meanwhile, XPS spectrum graph for C1s of the graphene aerogel prepared by the process of Example 1 is as shown in FIG. 6, and from which it was identified that graphene oxide reduction was effectively carried out in the preparation of a graphene hydrogel, so that the content of oxygen atoms in the graphene aerogel was rapidly decreased.

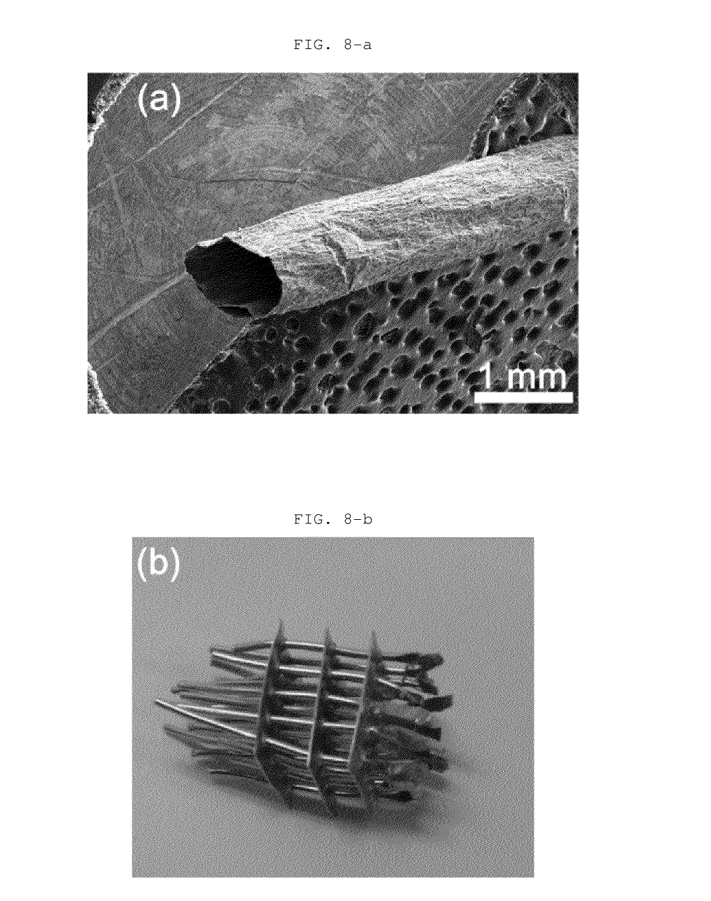

Also, the graph comparing Raman spectrum of graphene aerogel prepared by the process of Example 1 and graphene oxides is as shown in FIG. 7. As a result of checking crystal forms of graphene aerogel prepared by the process of Example 1 and graphene oxides, it was identified that the reduction of graphene oxides was very effectively carried out.

### Example 2

The method of the above Example 1 was followed, except that a zinc template of three-dimensional stereoscopic structure was used instead of a zinc metal mold, to form a graphene gel, and then the zinc template was removed, thereby obtaining a graphene gel of three-dimensional stereoscopic structure.

The SEM photograph of the graphene gel prepared by the process of Example 2 is as shown in FIG. 8-a.

### Example 3

2 mg/ml of titanium oxide nanoparticles (Aldrich Co.) were dispersed in D.I. water using ultrasonic waves, then stood for 10 minutes. When layers were separated, supernatant liquid was separately obtained to prepare a nanoparticle dispersion. Separately, 6 mg/ml of graphene oxides were mixed with 0.005M hydrochloric acid to prepare a graphene oxide solution. Subsequently, nanoparticle dispersion and graphene oxide solution were mixed in the same volume to prepare a mixed solution of graphene oxides and nanoparticles.

Besides, the process to obtain a graphene gel containing nanoparticles was carried out as in Example 1.

The SEM photograph of the graphene gel containing nanoparticles prepared by the process of Example 3 is as shown in FIG. 10-a.

### Example 4

The process of Example 3 was repeated, except that 2 mg/mL of silicon nanoparticles (Aldrich Co.) were used instead of 2 mg/mL of titanium oxide nanoparticles (Aldrich Co.), thereby preparing graphene gel nanocomposite materials.

The SEM photograph of the graphene gel containing nanoparticles prepared by the process of Example 4 is as shown in FIG. 10-b.

### Example 5

The process of Example 3 was repeated, except that carbon nanotube (CNT) was dispersed in 3 mg/mL of a graphene oxide solution, to prepare a mixed solution of graphene oxides and nanoparticles, and use it, thereby preparing graphene gel nanocomposite materials.

The SEM photograph of the graphene gel containing nanoparticles prepared by the process of Example 5 is as shown in FIG. 10-c.

The present invention may provide a graphene hydrogel having improved electrical conductivity and ion transport ability by including pores containing moisture, in a three-dimensional laminated structure of a thin film graphene hydrogel.

In addition, the present invention may provide graphene hydrogel nanocomposite materials capable of guaranteeing significantly excellent electrical efficiency, by improving dispersion of nanoparticles in a graphene sheet, in the three-dimensional laminated structure of a thin film graphene hydrogel.

In addition, a method capable of preparing a micro-sized thin film graphene hydrogel, and a large-area graphene hydrogel without limitation of size or shape, by a simplified process, may be provided.

In addition, a preparation method of graphene hydrogel nanocomposite materials being simple, and also capable of improving dispersion of nanoparticles in graphene sheets to guarantee excellent electrical efficiency, may be provided.

In addition, the graphene hydrogel or the graphene hydrogel nanocomposite materials prepared according to the present invention may be applied to various fields such as an energy storage device such as a secondary battery, a fuel cell and a super capacitor, a filtration membrane, a chemical detector, a transparent electrode.

Hereinabove, although the present invention is described by specific matters, limited exemplary embodiments, and drawings, they are provided only for assisting in the entire understanding according to the present invention. Therefore, the present invention is not limited to the exemplary embodiments. Various modifications and changes may be made by those skilled in the art to which the present invention pertains from this description.

Therefore, the spirit of the present invention should not be limited to the above-described exemplary embodiments, and the following claims as well as all modified equally or equivalently to the claims are intended to fall within the scope and spirit of the invention.

What is claimed is:

1. A graphene hydrogel comprising pores between laminated graphene sheets.

2. The graphene hydrogel of claim 1, wherein the graphene sheets are laminated in a quasi-aligned manner.

3. The graphene hydrogel of claim 1, wherein the pores contain water.

4. Graphene hydrogel nanocomposite materials comprising nanoparticles within pores between laminated graphene sheets.

5. The graphene hydrogel nanocomposite materials of claim 4, wherein the graphene sheets are laminated in a quasi-aligned manner.

6. The graphene hydrogel nanocomposite materials of claim 4, wherein the pores contain water.

7. The graphene hydrogel nanocomposite materials of claim 4, wherein the nanoparticles are contained in the pores.

8. The graphene hydrogel nanocomposite materials of claim 4, wherein the nanoparticles are one kind of nanoparticles, or two or more kinds of mixed nanoparticles selected from metal nanoparticles, precious metal nanoparticles, carbon nanoparticles, polymer nanoparticles, organic/inorganic hybrid nanoparticles, and oxides thereof.

9. A preparation method of a graphene hydrogel, comprising:
preparing a graphene oxide solution; and
immersing a metal mold in the graphene oxide solution, to laminate graphene sheets on a surface of the metal mold, thereby forming a graphene gel,
wherein pores are contained between the laminated graphene sheets.

10. The preparation method of a graphene hydrogel of claim 9, wherein in the forming of a graphene gel on the surface of the metal mold, as the graphene oxides are reduced on the surface of the metal mold, the graphene sheets are deposited on the surface of the metal mold in a laminated form.

11. A preparation method of graphene hydrogel nanocomposite materials, comprising:
preparing a mixed solution of graphene oxides and nanoparticles, and
immersing a metal mold in the mixed solution, to laminate graphene sheets on a surface of the metal mold, thereby forming a graphene gel containing nanoparticles,
wherein the nanoparticles are contained within the pores between the laminated graphene sheets.

12. The preparation method of graphene hydrogel nanocomposite materials of claim 11, wherein in the forming of the graphene gel containing the nanoparticles, as the graphene oxides are reduced on the surface of the metal mold, the graphene sheets are deposited on the surface of the metal mold in a laminated form, and the nanoparticles are contained in the pores formed by lamination of the graphene sheets.

13. The preparation method of graphene hydrogel nanocomposite materials of claim 11, wherein thin film fabric is adhered to the surface of the metal mold.

14. An article manufactured using the graphene hydrogel of claim 1.

15. The article of claim 14, wherein it is one of an energy storage device, an electromagnetic wave shielding material, a wastewater treatment reagent, an electrocatalyst material, a cell growth plate, and a graft material.

16. An article manufactured using the graphene hydrogel nanocomposite materials of claim 4.

17. The article of claim 16, wherein it is one of an energy storage device, an electromagnetic wave shielding material, a wastewater treatment reagent, an electrocatalyst material, a cell growth plate, and a graft material.
